(19) United States
(12) Patent Application Publication
(10) Pub. No.: US 2018/0085777 A1
(43) Pub. Date: Mar. 29, 2018

(54) FLUID DISCHARGE APPARATUS AND FLUID DISCHARGE METHOD

(71) Applicant: Seiko Epson Corporation, Tokyo (JP)

(72) Inventors: Hirofumi SAKAI, Shiojiri (JP); Keigo SUGAI, Chino (JP); Takahiro KATAKURA, Okaya (JP); Junichi SANO, Chino (JP); Shinichi NAKAMURA, Okaya (JP)

(21) Appl. No.: 15/703,196

(22) Filed: Sep. 13, 2017

(30) Foreign Application Priority Data
Sep. 29, 2016 (JP) 2016-190762

(51) Int. Cl. B05C 11/10; B41J 2/14; B41J 2/175; B41J 2/03

(52) U.S. Cl. CPC B05C 11/1034; B41J 2/14032; B41J 2/17556; B05C 5/0225; B41J 2/17503; B41J 2/17596; B41J 2/03

(57) ABSTRACT

A fluid discharge apparatus includes a storage chamber, a pressure chamber, a moving body, and a pressure changing mechanism. The storage chamber stores a fluid. The pressure chamber is in communication with the storage chamber through a communication opening, and includes a discharge port to discharge the fluid. The moving body moves inside the storage chamber toward the communication opening, raises a pressure of the fluid in the pressure chamber, and discharges the fluid through the discharge port. The pressure changing mechanism is provided so as to face the pressure chamber, and changes a pressure of the pressure chamber. The pressure changing mechanism actuates in a direction to reduce the pressure chamber pressure after the moving body has started to move toward the communication opening.

### BACKGROUND

### 1. Technical Field

The present invention relates to a fluid discharge apparatus and a fluid discharge method.

### 2. Related Art

Various fluid discharge apparatuses that discharge a fluid through a discharge port have been proposed. For example, JP-A-2002-282740 describes a liquid droplet discharge apparatus in which a plunger rod is moved back and forth in a liquid chamber, this being a housing section, so as to push a liquid out through a discharge port and discharge a liquid droplet. Fluid discharge mechanisms employing a moving body such as the plunger rod of JP-A-2002-282740 are sometimes employed in ink jet printers, these being printing apparatuses that discharge ink to produce printed material, and 3D printers, these being three-dimensional formation apparatuses that discharge a material in a liquid state to form a three-dimensional object.

In fluid discharge apparatuses such as that described above, sometimes fluid adhering to the periphery of the discharge port following fluid discharge obstructs subsequent fluid discharge. There is thus still room for improvement in technology to suppress fluid from remaining at the periphery of a discharge port following fluid discharge in fluid discharge apparatuses.

### SUMMARY

The invention may be implemented by the following aspects.

[1] A first aspect of the invention provides a fluid discharge apparatus. The fluid discharge apparatus includes a storage chamber, a pressure chamber, a moving body, and a pressure changing mechanism. The storage chamber stores the fluid. The pressure chamber includes a discharge port to discharge the fluid. The pressure chamber is in communication with the storage chamber through a communication opening that opens into the storage chamber. The moving body moves inside the storage chamber toward the communication opening so as to raise the pressure of the fluid in the pressure chamber and discharge the fluid through the discharge port. The pressure changing mechanism is provided so as to face the pressure chamber, and changes the pressure of the pressure chamber. The pressure changing mechanism actuates in a direction to reduce the pressure chamber pressure after the moving body has started to move toward the communication opening.

According to the fluid discharge apparatus of this aspect, actuating the pressure changing mechanism after fluid has started to be discharged through the discharge port generates a force in a direction from the discharge port toward the pressure chamber, enabling excess fluid to be drawn back toward the discharge port. Excess fluid is thereby suppressed from remaining in a peripheral edge region at the exterior of the discharge port following fluid discharge.

[2] The fluid discharge apparatus of the above aspect may be configured further including a controller that controls movement of the moving body, that executes discharge processing to discharge the fluid through the discharge port, and that actuates the pressure changing mechanism in coordination with a timing to move the moving body during the discharge processing.

According to the fluid discharge apparatus of this aspect, the pressure changing mechanism that is actuated under the control of the controller in coordination with movement of the moving body appropriately suppresses excess fluid from remaining in the peripheral edge region at the exterior of the discharge port following the execution of discharge processing.

[3] The fluid discharge apparatus of the above aspect may be configured wherein the pressure changing mechanism is actuated in a direction to reduce the pressure chamber pressure during discharge of the fluid through the discharge port, and causes at least a portion of the fluid that is being discharged through the discharge port to separate.

According to the fluid discharge apparatus of this aspect, actuation of the pressure changing mechanism is capable of promoting separation of a leading end portion of the fluid that is being discharged through the discharge port, thereby enabling fluid discharge performance to be improved.

[4] The fluid discharge apparatus of the above aspect may be configured wherein the fluid discharge apparatus further includes a communication chamber that is in communication with the pressure chamber, the pressure changing mechanism is actuated so as to change a capacity of a space inside the communication chamber, and actuation of the pressure changing mechanism in a direction to reduce the pressure chamber pressure is actuation to increase the capacity of the space inside the communication chamber.

According to the fluid discharge apparatus of this aspect, fluctuation in the capacity of the space inside the communication chamber is capable of generating a force in a direction from the discharge port toward the pressure chamber in the fluid that is being discharged through the discharge port, thereby suppressing excess fluid from remaining in the peripheral edge region at the exterior of the discharge port following fluid discharge.

[5] The fluid discharge apparatus of the above aspect may be configured wherein the pressure changing mechanism includes a valve body that performs an extension-retraction operation in the communication chamber so as to change the capacity of the space inside the communication chamber, and the controller controls the extension-retraction operation of the valve body in coordination with a timing to move the moving body during the discharge processing.

According to the fluid discharge apparatus of this aspect, excess fluid is suppressed from remaining in the peripheral edge region at the exterior of the discharge port following the execution of discharge processing by driving the valve body under the control of the controller in coordination with the movement of the moving body.

[6] The fluid discharge apparatus of the above aspect may be configured wherein the moving body moves inside the storage chamber in a first direction toward the communication opening and a second direction away from the communication opening, and during the discharge processing, the controller (i) discharges the fluid through the discharge port by moving the moving body in the second direction and then moving the moving body in the first direction, (ii) reduces the capacity of the space inside the communication chamber in a period of time after the moving body starting to move in the second direction and prior to the moving body starting to move in the first direction, and (iii) increases the capacity of the space inside the communication chamber in a period of time after the moving body has started to move in the first direction.

According to the fluid discharge apparatus of this aspect, refilling of a region between the discharge port and the moving body with the fluid can be promoted by reducing the capacity of the communication chamber. Moreover, subsequently increasing the capacity of the communication chamber enables a reduction in fluid remaining in the peripheral edge region of the discharge port. This thereby increases the efficiency of discharge processing execution.

[7] The fluid discharge apparatus of the above aspect may be configured wherein the fluid discharge apparatus further includes a fluid detection section that detects any of the fluid present at a peripheral edge region of the discharge port at the exterior of the pressure chamber, and during discharge processing, the controller controls the extension-retraction operation of the valve body after the fluid has started to be discharged through the discharge port according to an amount of the fluid detected by the fluid detection section.

According to the fluid discharge apparatus of this aspect, the fluid can be appropriately retained inside the discharge port while appropriately removing fluid remaining in the peripheral edge region of the discharge port.

[8] A second aspect of the invention provides a method for discharging a fluid from a discharge port. The method includes, inside a storage chamber that stores the fluid, moving a moving body toward a communication opening that opens into the storage chamber and is in communication with a pressure chamber including the discharge port, raising a pressure of the fluid in the pressure chamber, and starting discharge of the fluid through the discharge port. The method further includes actuating a pressure changing mechanism provided so as to face the pressure chamber and to change a pressure of the pressure chamber, the actuation being in a direction to reduce the pressure chamber pressure after the moving body has started to move toward the pressure chamber.

According to the method of this aspect, actuation of the pressure changing mechanism is used to suppress excess fluid from remaining in a peripheral edge region at the exterior of the discharge port.

The plural configuration elements included in each of the aspects of the invention described above are not all essential, and some of the plural configuration elements may be modified, omitted, exchanged for other configuration elements, or be freed of some of their limitations as appropriate in order to address some or all of the issues identified above, or in order to obtain some or all of the advantageous effects detailed in the present specification. Moreover, some or all of the technical features included in one aspect of the invention described above may be combined with some or all of the technical features included in another aspect of the invention described above to create an independent aspect of the invention in order to address some or all of the issues identified above, or in order to obtain some or all of the advantageous effects detailed in the present specification.

The invention may be implemented in various formats other than a fluid discharge apparatus and fluid discharge method. For example, the invention may be implemented by a printing apparatus or a three-dimensional formation apparatus provided with the functionality of the fluid discharge apparatus, a system provided with equivalent functionality to such apparatuses, a control method to control such apparatuses or systems, a computer program used to implement a fluid discharge method or the above control method, or a non-transient recording medium stored with such a computer program.

### BRIEF DESCRIPTION OF THE DRAWINGS

The invention will be described with reference to the accompanying drawings, wherein like numbers reference like elements.

FIG. 1 is a schematic diagram illustrating configuration of a fluid discharge apparatus of a first embodiment.

FIG. 2 is a schematic diagram illustrating configuration of a pressure changing mechanism of the first embodiment.

FIG. 3 is a flowchart illustrating an example of a flow of discharge steps during discharge processing.

FIG. 4 is an explanatory diagram illustrating an example of a timing chart for movement of a moving body and a valve body during discharge processing.

FIG. 5A is a schematic diagram illustrating a discharge section at the start of execution of discharge processing.

FIG. 5B is a schematic diagram illustrating the discharge section at step 1 to step 2 and at step a.

FIG. 5C is a schematic diagram illustrating the discharge section during execution of step 3 and step b.

FIG. 5D is a schematic diagram illustrating the discharge section following execution of step 3 and step b.

FIG. 6 is a schematic diagram illustrating configuration of a fluid discharge apparatus of a second embodiment.

FIG. 7 is a schematic diagram illustrating configuration of a fluid discharge apparatus of a third embodiment.

### DESCRIPTION OF EXEMPLARY EMBODIMENTS

### A. First Embodiment

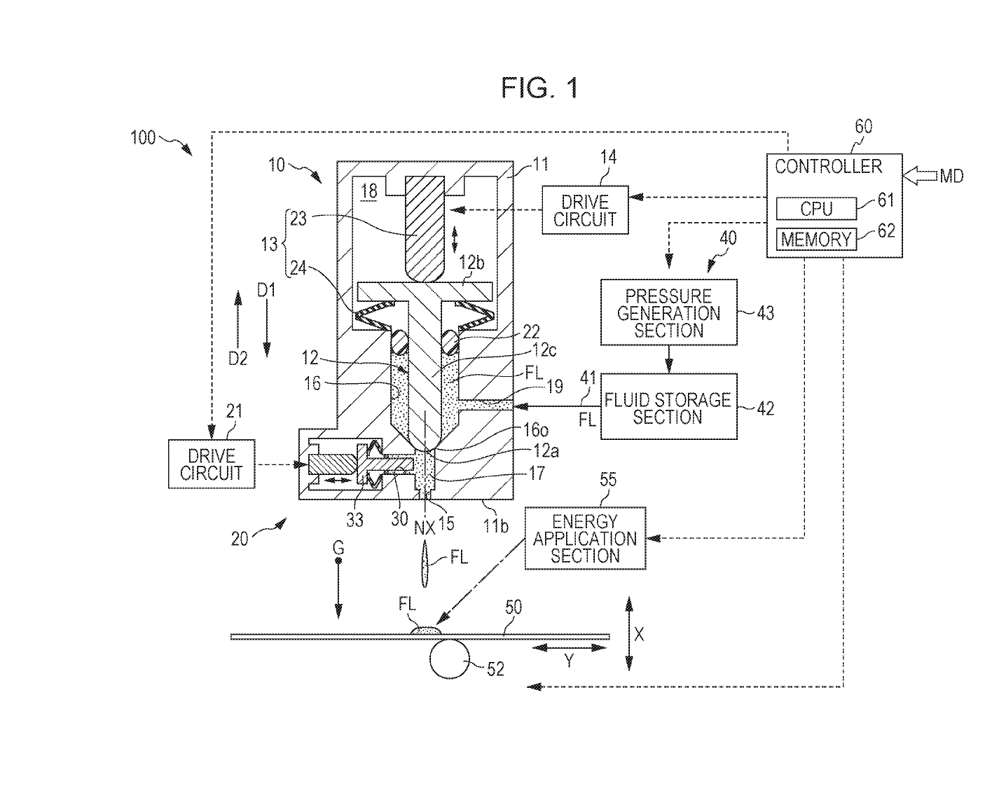

FIG. 1 is a schematic diagram illustrating configuration of a fluid discharge apparatus 100 of a first embodiment of the invention. In FIG. 1, the arrow G indicates the direction in which gravity acts (vertical direction) when the fluid discharge apparatus 100 is disposed in a normal usage state. FIG. 1 includes arrows indicating a first direction D1 and a second direction D2, described later. The arrows G, D1, and D2 are illustrated as appropriate in each of the drawings referenced in the present specification.

The fluid discharge apparatus 100 is a 3D printer, this being a three-dimensional formation apparatus. The fluid discharge apparatus 100 discharges a fluid FL to form a three-dimensional object by building up cured layers of the fluid FL. In the present specification, “discharging” refers to the use of some sort of force, including gravitational force, to expel a fluid to the exterior of a space in which the fluid is held, and includes the concept of “ejection”, in which fluid is expelled under pressure. Specific examples of the fluid FL discharged by the fluid discharge apparatus 100 as a material for forming a three-dimensional object, this being a formation target, will be described later. The fluid discharge apparatus 100 includes a discharge section 10 that discharges the fluid FL.

The discharge section 10 corresponds to a head section of the 3D printer, and discharges the fluid FL, this being a material with fluid characteristics, in fluid droplets. “Fluid droplets” refers to blob-shaped drops of the fluid, and refers to liquid droplets in cases in which the fluid is a liquid. The shape of the fluid droplets is not limited, and the fluid droplets may be spherical, may have a spherical shape extended in one direction, or may be needle-like or rod-like in shape. Moreover, there is no limitation to discharging a single fluid droplet with each discharge, and plural fluid droplets may be discharged. The discharge section 10 includes a housing section 11, a moving body 12, a drive mechanism 13, a first drive circuit 14, a pressure changing mechanism 20, and a second drive circuit 21.

The housing section 11 is configured as a hollow container, and houses the fluid FL, this being a discharge target of the discharge section 10, the drive mechanism 13 for discharging the fluid FL, and the pressure changing mechanism 20. In the present embodiment, the housing section 11 has a substantially circular cylinder shape, and is, for example, configured from stainless steel. A bottom face 11b of the housing section 11 is provided with a discharge port 15 that functions as a nozzle for discharging the fluid FL.

The discharge port 15 is in communication with a space inside the housing section 11, and is provided as a through hole with a substantially circular opening in cross-section. In the present embodiment, the discharge port 15 is formed along the vertical direction. The diameter of the opening of the discharge port 15 may be, for example, approximately 10 μm to 200 μm. The vertical direction length of the discharge port 15 may, for example, be approximately 10 μm to 30 μm.

A storage chamber 16, a pressure chamber 17, and a drive chamber 18 are provided inside the housing section 11. The storage chamber 16 stores the fluid FL. In the present embodiment, the storage chamber 16 is configured by a substantially circular column shaped cavity. The storage chamber 16 is connected to a flow path 19 for receiving fluid FL fed under pressure from a supply section 40, described later. The flow path 19 is configured as a tube that passes through an external wall of the housing section 11. A lower end of the storage chamber 16 is formed with a tapered shape decreasing in diameter on progression downward due to having an inclined wall face inclined downward on progression toward a communication opening 16o, this being in communication with the pressure chamber 17. This tapered portion may be omitted, with a bottom face of the storage chamber 16 being configured by a substantially horizontal face.

The pressure chamber 17 is positioned below the storage chamber 16. The pressure chamber 17 is in communication with the storage chamber 16 through the communication opening 16o opening into the storage chamber 16, such that the pressure chamber 17 is spatially continuous with the storage chamber 16. In the present embodiment, the communication opening 16o opens onto the lower end of the storage chamber 16. In the present embodiment, the pressure chamber 17 is configured by a substantially circular column shaped cavity, and a central axis of the pressure chamber 17 is aligned with a central axis of the storage chamber 16. An opening area of the pressure chamber 17 in cross-section taken orthogonally to the central axis of the pressure chamber 17 is smaller than an opening cross-section of the storage chamber 16 in cross-section taken orthogonally to the central axis of the storage chamber 16. Accordingly, flow path resistance of the fluid FL in the pressure chamber 17 is greater than the flow path resistance of the fluid FL in the storage chamber 16. As described later, the pressure chamber 17 is spatially partitioned from the storage chamber 16 by the moving body 12 when the moving body 12 is at a closed position that closes off the discharge port 15.

The discharge port 15 opens onto the lower end of the pressure chamber 17. In the present embodiment, the central axis of the pressure chamber 17 is aligned with a central axis NX of the discharge port 15. The opening area of the pressure chamber 17 in cross-section taken orthogonally to the central axis of the pressure chamber 17 is larger than the opening area of the discharge port 15 in cross-section taken orthogonally to the central axis NX, such that flow path resistance in the pressure chamber 17 is smaller than flow path resistance in the discharge port 15.

The drive chamber 18 is positioned above the storage chamber 16, and houses the drive mechanism 13. The drive chamber 18 is spatially partitioned from the storage chamber 16 by a sealing member 22, described later, such that the fluid FL stored in the storage chamber 16 does not enter the drive chamber 18. The drive mechanism 13 is thus protected from the fluid FL.

The moving body 12 is housed inside the housing section 11. The moving body 12 is disposed above the discharge port 15. In the present embodiment, the moving body 12 is configured by a column shaped metal member, and a central axis of the moving body 12 is disposed so as to be aligned with the central axis NX of the discharge port 15. The shape of the moving body 12 is not limited to a column shape. The moving body 12 may, for example, have a substantially triangular pyramid shape, or may have a substantially spherical shape.

The moving body 12 is disposed spanning between the storage chamber 16 and the drive chamber 18. A leading end portion 12a of the moving body 12 is housed in the storage chamber 16, and a rear end portion 12b of the moving body 12 is housed in the drive chamber 18. In the present embodiment, the leading end portion 12a of the moving body 12 has a hemispherical shape. The rear end portion 12b of the moving body 12 has a substantially circular disk shape that juts out in the horizontal direction. A main body 12c of the moving body 12 between the leading end portion 12a and the rear end portion 12b has a substantially circular column shape. The diameter of the main body 12c may be, for example, approximately 0.3 mm to 5 mm.

The circular ring shaped sealing member 22, configured by a resin O-ring, is disposed at the boundary between the storage chamber 16 and the drive chamber 18. The main body 12c of the moving body 12 is inserted through a through hole at the center of the sealing member 22. An outer peripheral face of the sealing member 22 forms an airtight contact with an inner wall face of the housing section 11, and an inner peripheral face of the sealing member 22 forms an airtight contact with a side face of the main body 12c of the moving body 12. The storage chamber 16 and the drive chamber 18 are thereby spatially partitioned from one another, as described above.

The moving body 12 is disposed inside the storage chamber 16 of the housing section 11 in a manner capable of moving in a first direction D1 toward the communication opening 16o that is in communication with the storage chamber 16, and in a second direction D2 moving away from the communication opening 16o. In the present embodiment, the first direction D1 and the second direction D2 are both parallel to the central axis of the moving body 12, and are parallel to the vertical direction. In the present embodiment, the moving body 12 moves back and forth along the central axis NX of the discharge port 15. The moving body 12 rubs against the inner peripheral face of the sealing member 22 as it moves. In the present embodiment, the moving body 12 moves over a range of approximately 10 μm to 500 μm.

When the moving body 12 is positioned at its lowermost position, the leading end portion 12a makes line contact with an opening-peripheral edge of the communication opening 16o of the storage chamber 16. A spatial connection between the storage chamber 16 and the discharge port 15 is thereby blocked off, closing the discharge port 15 off from the storage chamber 16. In the present specification, this position of the moving body 12 is referred to as the “closed position”.

The drive mechanism 13 applies drive force in order to move the moving body 12. The drive mechanism 13 includes a piezoelectric element 23, and an elastic member 24. The piezoelectric element 23 is configured by stacking plural piezoelectric materials, and a stacking direction length of the piezoelectric element 23 changes according to the magnitude of a voltage applied to the respective piezoelectric materials. The piezoelectric element 23 is applied with a voltage from the first drive circuit 14.

An upper end portion of the piezoelectric element 23 is fixed to an upper wall face of the drive chamber 18, and a lower end portion of the piezoelectric element 23 contacts the rear end portion 12b of the moving body 12. The moving body 12 moves in the first direction D1 when the piezoelectric element 23 extends so as to apply a load to the moving body 12.

The elastic member 24 biases the moving body 12 toward the second direction D2. In the present embodiment, the elastic member 24 is configured by a plate spring. The elastic member 24 is disposed at a lower side of the rear end portion 12b of the moving body 12 so as to surround the periphery of the main body 12c, and the elastic member 24 applies the rear end portion 12b with a force in the second direction D2. The elastic member 24 may be configured by a helical spring instead of a plate spring. When the piezoelectric element 23 has contracted, the moving body 12 moves in the second direction D2 following a lower end portion of the piezoelectric element 23 as a result of the force applied from the elastic member 24.

The discharge section 10 ejects a fluid droplet of the fluid FL through the discharge port 15 as a result of the moving body 12 moving back and forth under the control of a controller 60, described later. The mechanism by which fluid droplets are discharged by the discharge section 10 will be described later. Note that in the discharge section 10, a wall portion that configures the bottom face 11b of the housing section 11 and in which the discharge port 15 is provided may be configured by a member that can be removed from the body of the housing section 11. Removal of such a member from the housing section 11 facilitates cleaning and maintenance of the discharge port 15, as well as replacement and the like when deterioration or damage has occurred. Moreover, it becomes possible to switch between discharge ports 15 with various different opening diameters (nozzle diameters). Moreover, configuration may be made such that in the discharge section 10, the respective components housed in the housing section 11, such as the moving body 12, the seal member 22, and the elastic member 24 can be removed from the housing section 11. This facilitates maintenance and component replacement in the discharge section 10.

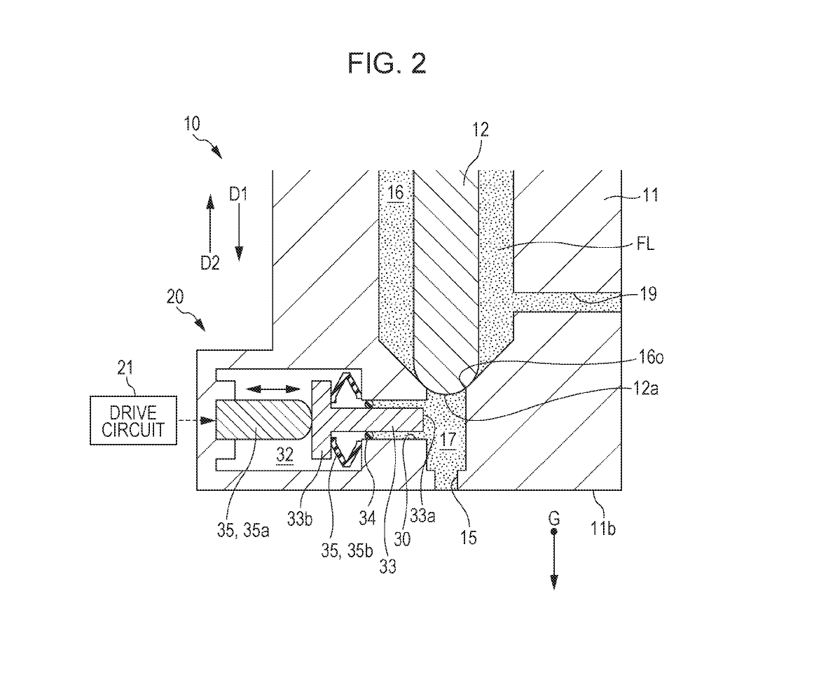

FIG. 2 is a schematic diagram illustrating configuration of the pressure changing mechanism 20 provided to the discharge section 10. FIG. 2 selectively illustrates a region of the discharge section 10 in the vicinity of the pressure changing mechanism 20. The pressure changing mechanism 20 is provided facing the pressure chamber 17. The pressure changing mechanism 20 is connected to the pressure chamber 17, and is actuated in order to change the pressure inside the pressure chamber 17. The pressure changing mechanism 20 includes a communication chamber 30, a drive chamber 32, a valve body 33, a sealing member 34, and a drive mechanism 35.

The communication chamber 30 is in communication with the pressure chamber 17, and stores fluid FL that flows in from the pressure chamber 17. In the present embodiment, the communication chamber 30 is provided inside the housing section 11 at a position adjacent to the pressure chamber 17. The communication chamber 30 is configured by a substantially circular column shaped cavity extending in a direction intersecting the central axis NX of the discharge port 15, and the communication chamber 30 opens onto a side wall face of the pressure chamber 17.

The drive chamber 32 is provided at a position adjacent to the communication chamber 30, and houses the drive mechanism 35 for driving the valve body 33. The valve body 33 is configured by a column shaped member. A leading end portion 33a of the valve body 33 is disposed in the communication chamber 30, and a rear end portion 33b of the valve body 33 is disposed in the drive chamber 32. The rear end portion 33b of the valve body 33 has a substantially circular disk shape jutting out in a radial direction of the valve body 33.

The circular ring shaped sealing member 34 is disposed at the boundary between the communication chamber and the drive chamber 32. The sealing member 34 is configured by a resin O-ring. The valve body 33 is inserted through and retained within a through hole through the center of the sealing member 34. An outer peripheral face of the sealing member 34 forms an airtight contact with an inner peripheral wall face of the communication chamber 30, and an inner peripheral face of the sealing member 34 forms an airtight contact with a side face of the valve body 33. An airtight partition is thus formed between the communication chamber 30 and the drive chamber 32, suppressing entry of the fluid FL into the drive chamber 32, and protecting the drive mechanism 35.

The valve body 33 is applied with drive force by the drive mechanism 35 of the drive chamber 32, and moves back and forth between the communication chamber 30 and the drive chamber 32 while rubbing against the inner peripheral face of the sealing member 34. Accordingly, the valve body 33 extends and retracts inside the communication chamber 30, thereby changing the capacity of a space inside the communication chamber 30. The capacity of the space inside the communication chamber 30 corresponds to a value obtained by subtracting the volume of a location on the leading end portion 33a side of the valve body 33 housed inside the communication chamber 30 from the volume of a space enclosed by internal wall faces of the communication chamber 30. The capacity of the space inside the communication chamber 30 represents the capacity of the communication chamber 30 to store the fluid FL.

The drive mechanism 35 includes a piezoelectric element 35a and an elastic member 35b. The piezoelectric element 35a is configured by stacking plural piezoelectric materials, and a stacking direction length of the piezoelectric element 35a changes according to the magnitude of a voltage applied to the respective piezoelectric materials. The piezoelectric element 35a is applied with a voltage from the second drive circuit 21. The second drive circuit 21 applies a voltage to the piezoelectric element 35a in response to a command from the controller 60.

One stacking direction end portion of the piezoelectric element 35a is fixed to a wall face of the drive chamber 32, and another stacking direction end portion of the piezoelectric element 35a contacts the rear end portion 33b of the valve body 33. The valve body 33 moves toward the pressure chamber 17 as a result the piezoelectric element 35a extending and pressing the rear end portion 33b of the valve body 33, thereby extending the length by which the valve body 33 projects into the communication chamber 30. The capacity of the space inside the communication chamber is reduced as a result of extending the length of the valve body 33 inside the communication chamber 30.

The elastic member 35b biases the valve body 33 in a direction away from the pressure chamber 17. In the present embodiment, the elastic member 35b is configured by a plate spring. The elastic member 35b is disposed so as to surround the periphery of the valve body 33 further to the leading end portion 33a side of the valve body 33 than the rear end portion 33b, and contacts the rear end portion 33b that juts out in a flange shape so as to apply an elastic force to the valve body 33. The elastic member 35b may be configured by a helical spring instead of a plate spring.

When the piezoelectric element 35a contracts, following the contraction of the piezoelectric element 35a, the valve body 33 moves in the direction away from the pressure chamber 17 as a result of the force applied from the elastic member 35b, thereby reducing the length by which the valve body 33 projects into the communication chamber 30. The capacity of the space inside the communication chamber is increased as a result of reducing the length of the valve body 33 inside the communication chamber 30.

In the pressure changing mechanism 20 of the present embodiment, the extension-retraction operation of the valve body 33 in the communication chamber 30 changes the amount of fluid FL housed in the communication chamber 30, thereby changing a pressure state of the pressure chamber 17. When the discharge section 10 discharges the fluid FL, the pressure changing mechanism 20 actuates under the control of the controller 60 in a direction to reduce the pressure of the pressure chamber 17. This process will be described in detail later.

Explanation now returns to FIG. 1. In addition to the discharge section 10 described above, the fluid discharge apparatus 100 further includes the supply section 40, a formation stage 50, a moving mechanism 52, an energy application section 55, and the controller 60. The supply section 40 feeds the fluid FL under pressure to the storage chamber 16 of the housing section 11, via the flow path 19. The supply section 40 includes a tube 41, a fluid storage section 42, and a pressure generation section 43.

The tube 41 connects the flow path 19 of the housing section 11 to the fluid storage section 42. The fluid storage section 42 is the source of fluid FL supply in the fluid discharge apparatus 100, and is configured by a tank that stores the fluid FL. In the fluid storage section 42, a solvent is mixed with the stored fluid FL so as to maintain the viscosity of the fluid FL at a predetermined specific viscosity. The viscosity of the fluid FL may, for example, be approximately 50 mPa·s to 40,000 mPa·s.

The pressure generation section 43 is, for example, configured by a pressurizing pump. The pressure generation section 43 applies pressure to the fluid FL in the fluid storage section 42 in order to feed the fluid FL under pressure to the housing section 11 via the tube 41. For example, the pressure generation section 43 applies a pressure of approximately 0.4 MPa to 0.6 MPa to the fluid FL. Note that in FIG. 1, the pressure generation section 43 is provided upstream of the fluid storage section 42. However, the pressure generation section 43 may be provided downstream of the fluid storage section 42.

The formation stage 50 is disposed ahead of the discharge section 10 in the opening direction of the discharge port 15. The discharge section 10 discharges the fluid FL, using the formation stage 50 as a target object. A three-dimensional object is formed by fluid droplets of the fluid FL that have landed on the formation stage 50. In the present embodiment, the formation stage 50 is configured by a flat plate shaped member, and is disposed in the horizontal direction. The formation stage 50 is, for example, disposed at a position at a separation of approximately 1.5 mm to 3 mm below the discharge port 15 in the vertical direction.

The moving mechanism 52 includes motors, rollers, shafts, and various actuators that displace the formation stage 50 with respect to the discharge section 10. As illustrated by the arrows X and Y in FIG. 1, the moving mechanism 52 displaces the formation stage 50 in the horizontal direction and the vertical direction relative to the discharge section 10. The position at which the fluid FL lands on the formation stage 50 is adjusted in this manner. Note that the fluid discharge apparatus 100 may be configured such that the formation stage 50 is fixed, with the discharge section 10 being displaced with respect to the formation stage 50.

The energy application section 55 applies energy to the fluid FL that has landed on the formation stage 50, thereby curing the fluid FL. In the present embodiment, the energy application section 55 is configured by a laser device, and light energy is imparted to the fluid FL by irradiating with the laser. The energy application section 55 includes, as a minimum, a laser light source, a focusing lens to focus a laser emitted by the laser light source on the fluid FL that has landed on the formation stage 50, and a galvanometer mirror to cause the laser to scan (not illustrated in the drawings). The energy application section 55 scans across a position where fluid droplets have landed on the formation stage 50 with the laser, such that light energy of the laser sinters together powdered material within the fluid FL. Alternatively, powdered material within the fluid FL may be melted before then being fused together. A layer of material configuring the three-dimensional object is thereby formed on the formation stage 50.

The energy application section 55 may cure the fluid FL using a method other than laser irradiation. The energy application section 55 may cure the fluid FL by ultraviolet irradiation, or may use a heater to apply heat to drive off at least some of the solvent in the fluid FL and cure the powdered material.

The controller 60 is configured by a computer including a CPU 61 and memory 62. The CPU 61 reads and executes a computer program from the memory 62 in order to implement various functions in order to control the fluid discharge apparatus 100. The controller 60 executes formation processing to respectively control the discharge section 10, the supply section 40, the moving mechanism 52, and the energy application section 55 described above in order to form the three-dimensional object.

The controller 60 receives data MD for forming a three-dimensional object from an external computer (not illustrated in the drawings) connected to the fluid discharge apparatus 100. The data MD includes data representing each layer of material to be built up in a height direction of the three-dimensional object. Based on the data MD, the controller 60 determines timings at which to cause the discharge section 10 to discharge fluid droplets of the fluid FL, and determines the size of the fluid droplets. Moreover, based on the data MD, the controller 60 determines fluid FL fluid droplet landing positions on the formation stage 50, and laser irradiation positions and irradiation timings of the energy application section 55. Note that the three-dimensional object formed on the formation stage 50 may undergo a sintering process in an oven when appropriate.

In the formation processing, the controller 60 transmits drive signals to the first drive circuit 14 to execute discharge processing so as to control movement of the moving body 12 of the discharge section 10, and to cause the discharge section 10 to discharge the fluid FL. Moreover, in the discharge processing, the controller 60 transmits drive signals to the second drive circuit 21 to control actuation of the pressure changing mechanism 20. The control of the moving body 12 and control of the pressure changing mechanism 20 by the controller 60 in discharge processing will be described in detail later.

Based on the above configuration, the fluid discharge apparatus 100 of the present embodiment uses the fluid FL subject to discharge as the material for forming the three-dimensional object. Explanation follows regarding specific examples of the fluid FL used as the material for the three-dimensional object. In the present embodiment, the fluid FL is a fluid composition in paste form, and includes a powdered material and a solvent. The fluid FL may include a powdered material and a solvent. For example, the powdered material may be a powder of a single substance out of magnesium (Mg), iron (Fe), cobalt (Co), chromium (Cr), aluminum (Al), titanium (Ti), copper (Cu), or nickel (Ni), may be an alloy powder containing one or more out of the foregoing metals (maraging steel, stainless steel, cobalt-chromium-molybdenum, a titanium alloy, a nickel alloy, an aluminum alloy, a cobalt alloy, or a cobalt-chromium alloy), or may be a mixed power combining one or two or more powders selected from the single-substance powders and/or the alloy powders. For example, the solvent in the fluid FL may be: water; a (poly)alkylene glycol monoalkyl ether such as ethylene glycol monomethyl ether, ethylene glycol monoethyl ether, propylene glycol monomethyl ether, or propylene glycol monoethyl ether; an acetic acid ester such as ethyl acetate, n-propyl acetate, iso-propyl acetate, n-butyl acetate, or iso-butyl acetate; an aromatic hydrocarbon such as benzene, toluene, or xylene; a ketone such as methyl ethyl ketone, acetone, methyl isobutyl ketone, ethyl-n-butyl ketone, diisopropyl ketone, or acetyl acetone; an alcohol such as ethanol, propanol, or butanol; a tetraalkyl ammonium acetate; a sulfoxide-based solvent such as dimethyl sulfoxide or diethylsulfoxide; a pyridine-based solvent such as pyridine, γ-picoline, or 2,6-lutidine; an ionic liquid such as a tetraalkyl ammonium acetate (for example, tetrabutyl ammonium acetate or the like); or a combination that includes one or two or more solvents selected from these.

The fluid FL may be configured in slurry form by mixing a binder with the powdered material and solvent described above, or may be configured as a mixed material in paste form. For example, the binder may be: an acrylic resin, an epoxy resin, a silicone resin, a cellulose-based resin, or another synthetic resin; or polylactic acid (PLA), polyamide (PA), polyphenylene sulfide (PPS), or another thermoplastic resin. The fluid FL is not limited to fluids that include the above as powered materials, and may, for example, be a melted resin such as a general purpose engineering plastic such as a polyamide, a polyacetal, a polycarbonate, a modified polyphenylene ether, polybutylene terephthalate, or polyethylene terephthalate. Other examples that may be employed as the fluid FL include resins such as engineering plastics such as a polysulfone, a polyether sulfone, a polyphenylene sulfide, a polyarylate, a polyimide, a polyamide-imide, a polyether imide, or a polyether ether ketone. The fluid FL may include a metal other than the metals above, a ceramic, a resin, or the like. The fluid FL may include a sintering agent.

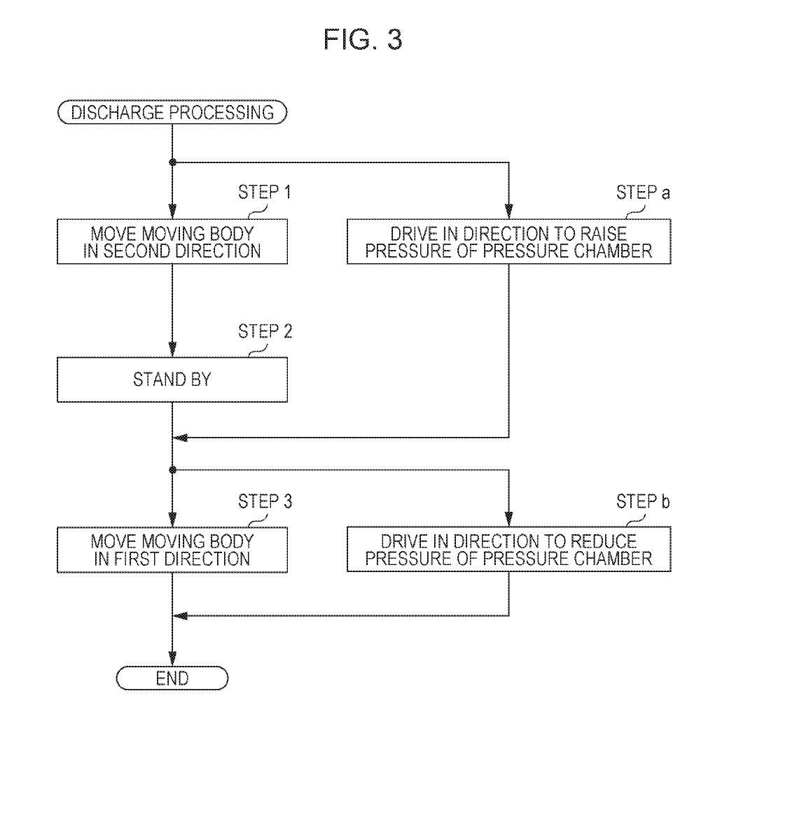

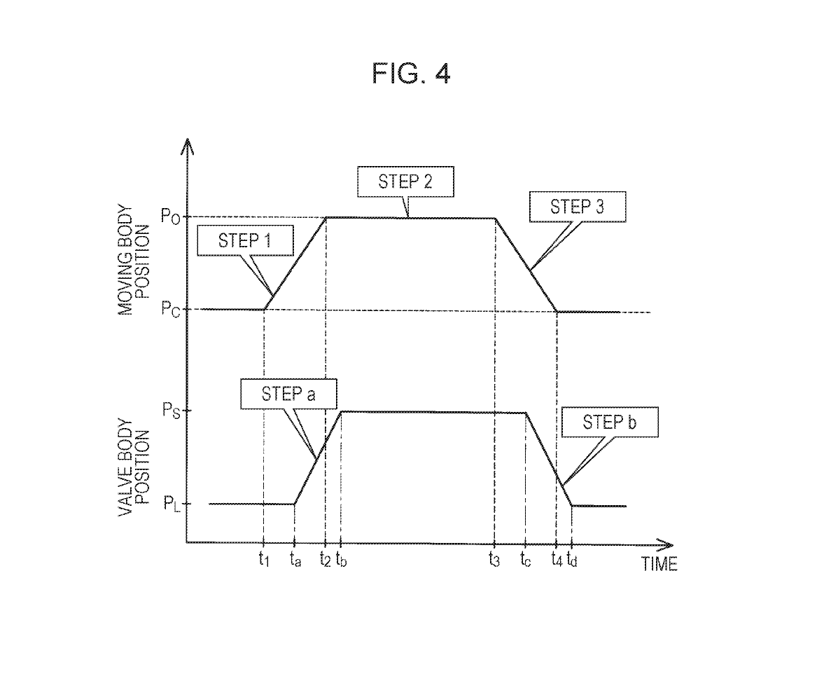

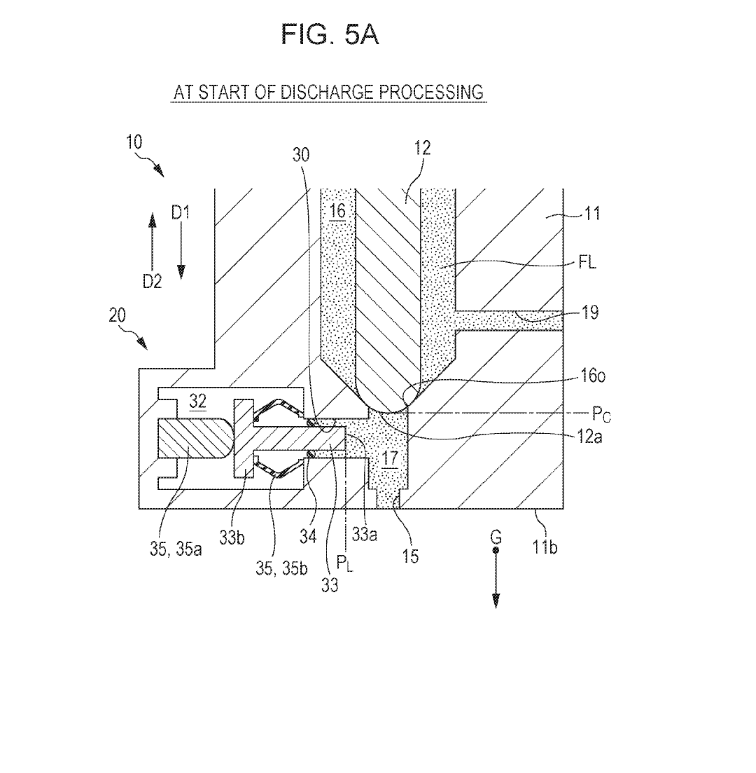

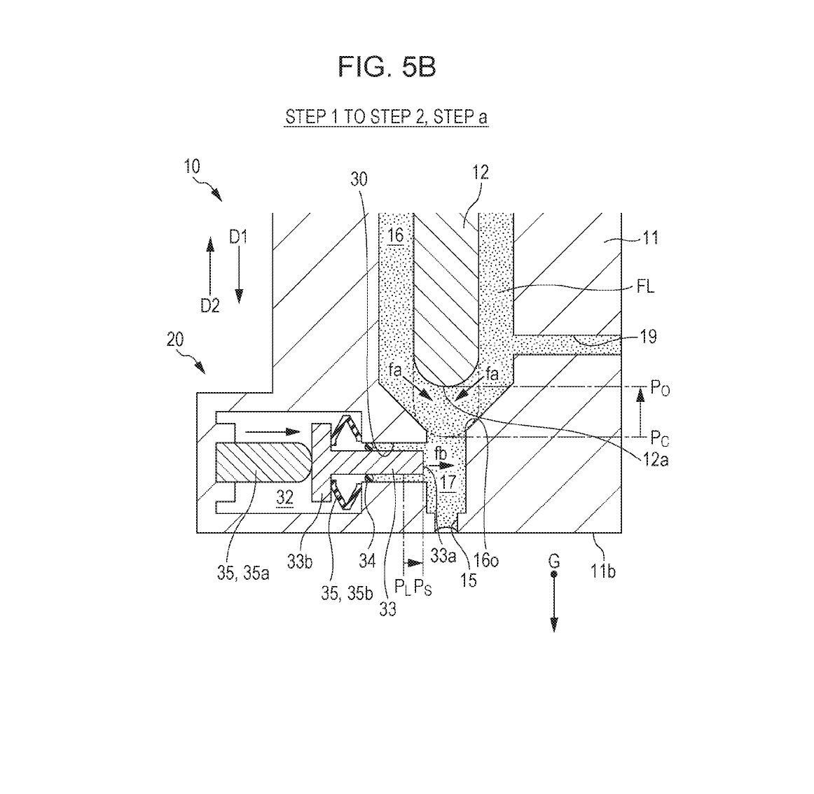

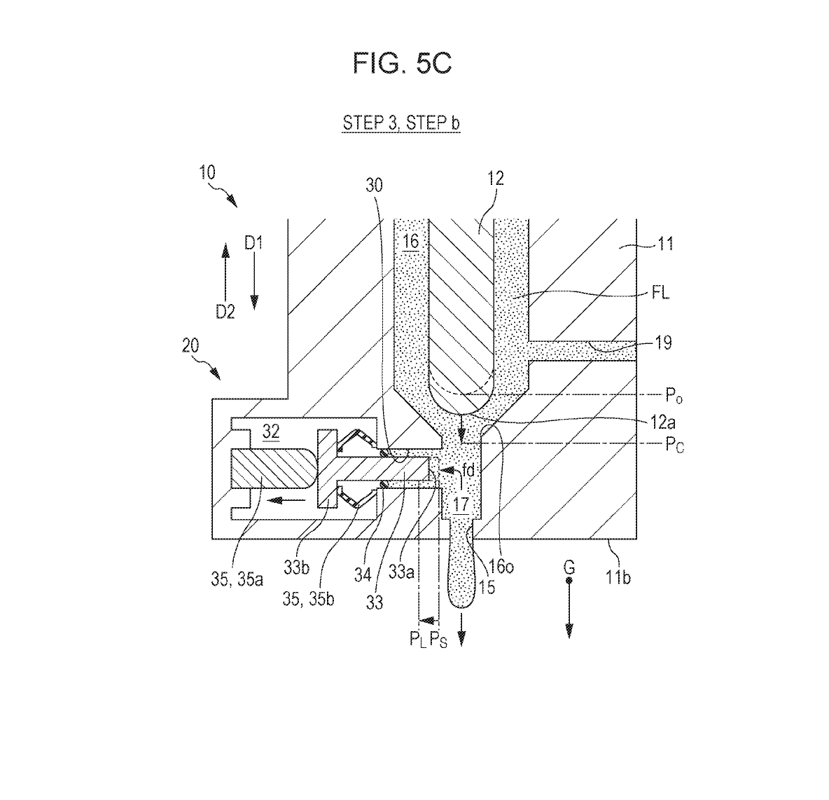

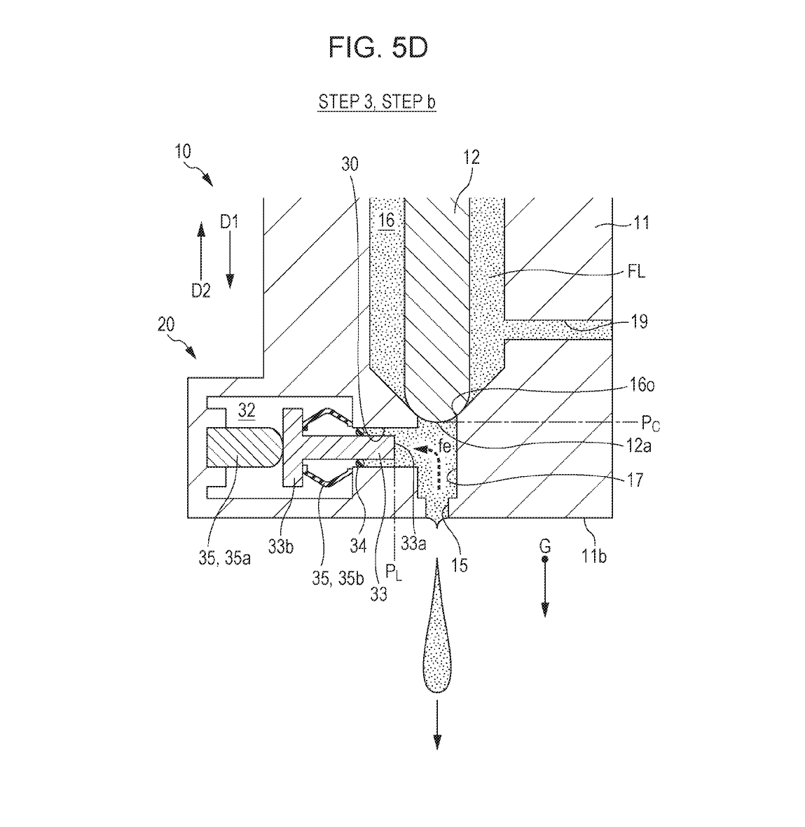

Explanation follows regarding control by the controller 60 during discharge processing, and the mechanism by which the fluid FL is discharged, with reference to FIG. 3, FIG. 4, and FIG. 5A to FIG. 5D. FIG. 3 is a flowchart illustrating an example of a flow of fluid FL discharge steps during discharge processing. FIG. 4 is an explanatory diagram illustrating an example of a timing chart of movement of the moving body 12 and the valve body 33 during discharge processing. In the timing chart of FIG. 4, the positions of the moving body 12 and the positions of the valve body 33 on the vertical axis respectively correspond to the magnitude of the voltages applied to the piezoelectric elements 23, 35a corresponding to the respective drive circuits 14, 21. Each of FIG. 5A to FIG. 5D are schematic diagrams illustrating the discharge section 10 in chronological order during discharge processing. Each of FIG. 5A to FIG. 5D selectively illustrate a region in the vicinity of the discharge port 15, including the pressure changing mechanism 20.

The controller 60 executes discharge processing upon reaching a timing for discharge of the fluid FL by the discharge section 10 during the formation processing. Executing the discharge processing a single time discharges a fluid droplet containing an amount equivalent to a single dot through the discharge port 15 of the discharge section 10. Steps 1 to 3 and steps a and b are executed during discharge processing (FIG. 3). Steps 1 to 3 are steps to control movement of the moving body 12 of the discharge section 10, and steps a and b are steps to control drive of the pressure changing mechanism 20, executed in parallel with the movement control of the moving body 12. In the present embodiment, the controller 60 controls the extension-retraction operation of the valve body 33 of the pressure changing mechanism 20 in steps a and b in coordination with the movement timing of the moving body 12 in steps 1 to 3. At the start of execution of the discharge processing, the moving body 12 is positioned at a closed position P_{C} that closes off the discharge port 15 in the storage chamber 16, and the valve body 33 in the communication chamber 30 is positioned at a first position P_{L} that is furthest from the pressure chamber 17 such that the space inside the pressure chamber 17 is at its maximum capacity (FIG. 5A).

At step 1, the controller 60 uses the first drive circuit 14 to apply a voltage to the piezoelectric element 23, causing the piezoelectric element 23 to contract so as to move the moving body 12 in the second direction D2 from the closed position P_{C} (the time t₁ in FIG. 4). The storage chamber 16 and the pressure chamber 17 are thus placed in a communicated state, opening the discharge port 15. At step 1, the moving body 12 reaches an open position P_{O}, this being the furthest position from the discharge port 15 in the movement range of the moving body 12 (the time t₂ in FIG. 4, FIG. 5B). The duration of the movement of the moving body 12 at step 1 (times t₁ to t₂) may, for example, be approximately 50 μs to 400 μs.

At step 2, for a predetermined momentary standby duration, the voltage applied to the piezoelectric element 23 is maintained so as to retain the moving body 12 at the open position P_{O} (the times t₂ to t₃ in FIG. 4). During this duration, the pressure of the storage chamber 16 is used as a driving force to cause the fluid FL to flow into and refill a region between the leading end portion 12a of the moving body 12 and the discharge port 15, as illustrated by the arrows fa inside the storage chamber 16 in FIG. 5B. The standby duration at step 2 may be determined as appropriate according to the viscosity of the fluid FL, the pressure applied to the fluid FL by the pressure generation section 43, the capacity of the storage chamber 16, and so on. For example, the standby duration may be approximately 100 μs to 300 μs. Note that the standby duration at step 2 is preferably set to a duration reduced to the minimum duration sufficient to refill the fluid FL from the communication chamber 30 in step a, as described below.

The controller 60 executes step a between steps 1 to 2 (the times tₐ to t_{b} in FIG. 4). At step a, the controller 60 actuates the pressure changing mechanism 20 in the direction that raises the pressure of the pressure chamber 17. Using the second drive circuit 21, the controller 60 applies a voltage to the piezoelectric element 35a of the pressure changing mechanism 20 so as to extend the piezoelectric element 35a. Accordingly, the valve body is extended into the communication chamber 30, and the leading end portion 33a moves from the first position P_{L} to a second position P_{S}, where the capacity of the space inside the communication chamber 30 is at its smallest (FIG. 5B). The extension of the valve body 33 into the communication chamber 30 reduces the capacity of the space inside the communication chamber 30, such that the fluid FL in the communication chamber 30 is pushed out into the pressure chamber 17 as illustrated by the arrow fb, thereby promoting refilling of the region between the leading end portion 12a of the moving body 12 and the discharge port 15 with the fluid FL.

FIG. 4 illustrates an example in which execution of step a is started between the times t₁ and t₂, during execution of step 1. The start timing of execution of step a is not limited to the timing in the example illustrated in FIG. 4. The start timing of execution of step a may be at the same time as the moving body 12 starts to move in step 1, or may be after the moving body 12 has started to move in step 1. The start timing of execution of step a may be after the completion of execution of step 1, or may be during the standby duration of step 2.

At step 3, the controller 60 changes the voltage applied to the piezoelectric element 23 by the first drive circuit 14, such that the piezoelectric element 23 extends so as to move the moving body 12 in the first direction D1 (the times t₃ to t₄ in FIG. 4). When the moving body 12 starts moving in the first direction D1, the fluid FL in the storage chamber 16 is pressed by the moving body 12, thereby raising the pressure of the fluid FL in the pressure chamber such that the fluid FL starts to be discharged through the discharge port 15 (FIG. 5C). At step 3, the moving body moves to the closed position P_{C}, and the leading end portion 12a meets the opening-peripheral edge of the communication opening 16o so as to close off the discharge port 15 (FIG. 5D).

At step 3, the load applied to the moving body 12 from the piezoelectric element 23 may be determined according to a target pressure of the fluid FL in the discharge port 15 when discharging the fluid FL through the discharge port 15. For example, in a case in which the target pressure is approximately 900 MPa to 1100 MPa, the load applied to the moving body 12 by the piezoelectric element 23 may be in the order of several hundred N.

The controller 60 executes step b in coordination with the timing of execution of step 3 (the times t_{c} to t_{d} in FIG. 4). The controller 60 starts execution of step b (time t_{c} in FIG. 4) at a predetermined timing after the moving body 12 starts moving in the first direction D1 at step 3. At step b, the controller 60 actuates the pressure changing mechanism 20 in the direction to reduce the pressure in the pressure chamber 17. The controller 60 changes the voltage applied to the piezoelectric element 35a by the second drive circuit 21 such that the piezoelectric element 35a starts to contract, and such that the valve body 33 starts to retract from the communication chamber 30 (FIG. 5C). The leading end portion 33a of the valve body 33 moves from the second position P_{S} to the first position P_{L}, thereby increasing the capacity of the space inside the communication chamber 30 such that the fluid FL flows into the communication chamber 30. Accordingly, some of the pressure in the pressure chamber 17 is relieved by the communication chamber 30, and a force in a direction from the discharge port 15 toward the pressure chamber 17 arises in the fluid FL that is being discharged through the discharge port 15, as illustrated by the arrow fd.

During execution of step b, a location at a lower end side of discharged fluid FL dangling from the discharge port 15 is subject to gravitational force and inertial force in the vertical direction, arising as a result of the movement of the moving body 12 in the first direction D1 at step 3 described above. When the force in the direction from the discharge port 15 toward the pressure chamber 17 arises at step b as described above, a location on the discharge port 15 side of the fluid FL that is being discharged through the discharge port 15 is subjected to a force in a direction drawing the fluid FL back inside the discharge port 15 (the arrow fd). This thereby promotes separation of the location at the lower end side of the fluid FL discharged through the discharge port 15. A fluid droplet that flies toward the target object is thereby generated smoothly, thus improving the fluid FL discharge performance of the discharge section 10. Moreover, even after the fluid droplet has separated, the above force generated in step b acts on the remaining fluid FL in the discharge port 15 in the direction to draw the fluid FL back into the pressure chamber 17 (arrow fe in FIG. 5D). The fluid FL is thereby suppressed from remaining in a peripheral edge region at the exterior of the discharge port 15 following discharge of the fluid FL.

FIG. 4 illustrates an example in which a reduction in the capacity of the space inside the communication chamber 30 is started after the moving body 12 has started moving in the first direction D1 at step 3, and the capacity of the space inside the communication chamber 30 is at its greatest after the moving body 12 has reached the closed position P_{C}. The period of time in which step b is executed is not limited to the period of time in the example illustrated in FIG. 4. At step b, the timing at which to start reducing the capacity of the space inside the communication chamber 30 may be a timing at which the fluid FL starts to be discharged through the discharge port 15. The timing at which the fluid FL starts to be discharged through the discharge port 15 may be a timing determined in advance by testing for when the fluid FL may be expected to start being discharged through the discharge port 15 after the moving body 12 has started to move in the first direction D1. The timing at which the capacity of the space inside the communication chamber 30 reaches its greatest at step b may be earlier than the timing at which the moving body 12 reaches the closed position P_{C} at step 3.

Execution of step b preferably starts during discharge of the fluid FL through the discharge port 15. As described above, such a configuration enables the force in a direction to draw the fluid FL being discharged through the discharge port 15 back into the pressure chamber 17 to be generated, thereby achieving smoother fluid droplet generation. “During discharge of the fluid FL through the discharge port 15” refers to a period of time when the fluid FL is dangling from the discharge port 15 in a column shape, and does not include a period of time after the location at the leading end of the column shaped fluid FL has separated into a fluid droplet. Namely, this period of time is a period of time after the fluid FL starts to be discharged through the discharge port 15, and prior to separation of a fluid droplet of the fluid FL.

As described above, according to the fluid discharge apparatus 100 and the fluid FL discharge method of the discharge processing of the present embodiment, actuation of the pressure changing mechanism 20 can be used to draw excess fluid FL back inside the housing section 11 after discharging fluid FL through the discharge port 15. Accordingly, excess fluid FL is suppressed from remaining in the peripheral edge region of the discharge port 15, and such excess fluid FL is suppressed from obstructing subsequent fluid FL discharge, thereby enabling smooth repeated discharge of fluid FL fluid droplets. Moreover, it is possible to suppress irregularity in the size of the fluid droplets, and irregularity in the shape of the droplets of the fluid FL discharged in subsequent discharge steps as a result of fluid FL remaining in the peripheral edge region of the discharge port 15, thereby enabling detriment to the flight quality and the like of the fluid droplets to be suppressed. In addition, excess fluid FL is suppressed from adhering to the peripheral edge region of the discharge port 15, thereby enabling the frequency with which cleaning of the peripheral edge region of the discharge port 15 is executed to be reduced, improving efficiency. Moreover, according to the fluid discharge apparatus 100 and the fluid FL discharge method of the discharge processing of the present embodiment, actuation of the pressure changing mechanism 20 is used to promote the separation of fluid droplets from the fluid FL discharged through the discharge port 15. This thereby suppresses, for example, a situation in which fluid droplets trail or otherwise do not separate appropriately, leading to irregularity in the size of the fluid droplets or detriment to the flight quality of the fluid droplets. The fluid discharge apparatus 100 and the fluid FL discharge method of the discharge processing of the present embodiment are moreover capable of exhibiting the various operation and advantageous effects described in the foregoing embodiment.

### B. Second Embodiment

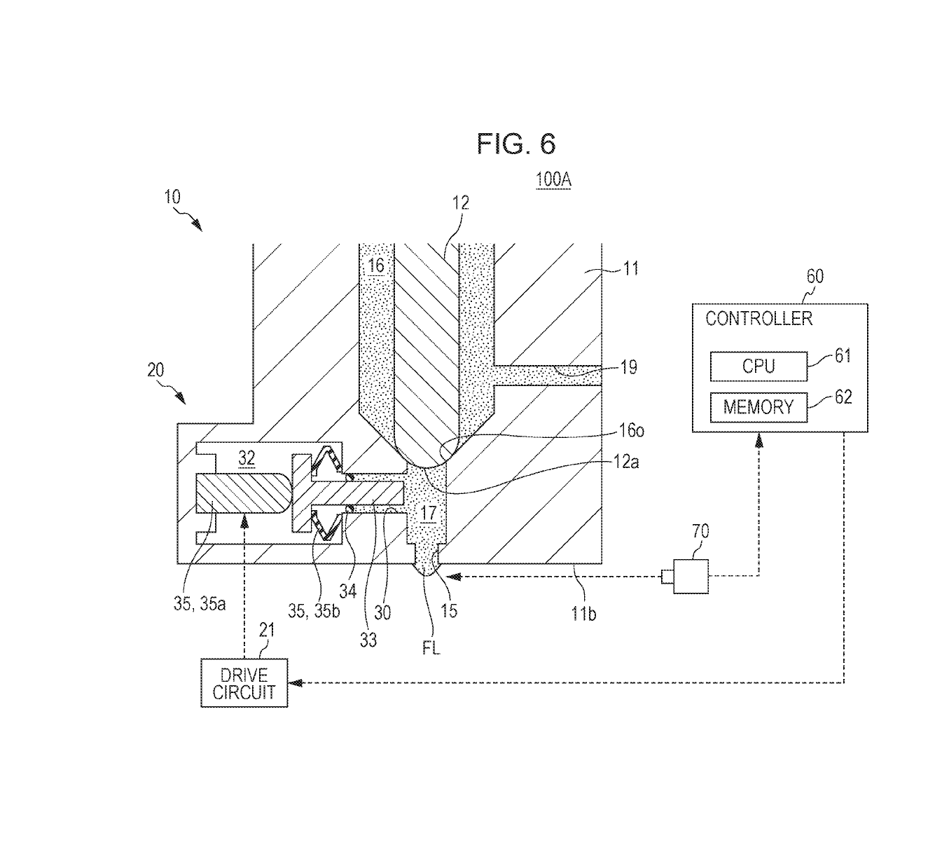

FIG. 6 is a schematic diagram illustrating configuration of a fluid discharge apparatus 100A of a second embodiment of the invention. For the sake of convenience, FIG. 6 illustrates only some configuration sections of the fluid discharge apparatus 100A. The fluid discharge apparatus 100A of the second embodiment has substantially the same configuration as the fluid discharge apparatus 100 of the first embodiment, with the exception of the point that a fluid detection section 70 is additionally provided. As described below, discharge processing executed by the fluid discharge apparatus 100A of the second embodiment is substantially the same as that described in the first embodiment, with the exception of the point that the extension-retraction operation of the valve body 33 of the pressure changing mechanism 20 is controlled according to a detection result of the fluid detection section 70.

Under the control of the controller 60, the fluid detection section 70 optically detects fluid FL remaining at the peripheral edge region of the discharge port 15 at the exterior of the housing section 11. The fluid detection section 70 includes an imaging element configured by a CCD image sensor or the like. The fluid detection section 70 images the peripheral edge region the discharge port 15 and analyzes the resulting images when the discharge section 10 is not executing discharge processing of the fluid FL. The thickness of a film of the fluid FL formed covering the discharge port 15 at the underside of the discharge port 15, and the area of this film in the image, are detected as values representing the amount of fluid FL present in the peripheral edge region of the discharge port 15.

Depending on the amount of fluid FL detected by the fluid detection section 70, the controller 60 controls the degree to which the pressure changing mechanism 20 reduces the pressure in the storage chamber 16 at step b the next time discharge processing is performed. The controller 60 controls the extension-retraction operation of the valve body 33 according to the amount of fluid FL detected by the fluid detection section 70. The controller 60 may increase the movement distance of the valve body 33 at step b the greater the amount of fluid FL detected by the fluid detection section 70. The controller 60 may increase the movement distance of the valve body 33 at step b when the amount of fluid FL detected by the fluid detection section 70 exceeds a predetermined threshold value.

Increasing the movement distance of the valve body at step b enables the amount of fluid FL drawn back toward the discharge port 15 following fluid FL discharge to be increased, and thus enables the amount of fluid FL remaining in the peripheral edge region of the discharge port 15 to be decreased. Moreover, when the amount of fluid FL detected to be remaining in the peripheral edge region of the discharge port 15 is small, an unnecessarily excessive reduction of the fluid FL in the discharge port 15 is suppressed. Accordingly, poor fluid FL discharge resulting from, for example, fluid droplets not being discharged with an appropriate size or shape due to insufficient fluid FL inside the discharge port 15 is suppressed from occurring.

The controller 60 may increase the movement speed of the valve body 33 at step b, thereby increasing the amount of fluid FL drawn back toward the discharge port 15, the greater the amount of fluid FL detected by the fluid detection section 70. Alternatively, the controller 60 may increase the movement speed of the valve body 33 when the amount of fluid FL detected by the fluid detection section has exceeded a predetermined threshold value. Such control is capable of obtaining similar advantageous effects to those described above.

As described above, the fluid discharge apparatus 100A and the fluid FL discharge method of the discharge processing of the second embodiment are capable of suppressing fluid FL from remaining at the peripheral edge region of the discharge port 15, and also capable of maintaining an appropriate fluid FL amount inside the discharge port 15. Additionally, the fluid discharge apparatus 100A and the fluid FL discharge method of the discharge processing of the second embodiment are capable of exhibiting various operation and advantageous effects similar to those explained above with regard to the first embodiment.

### C. Third Embodiment

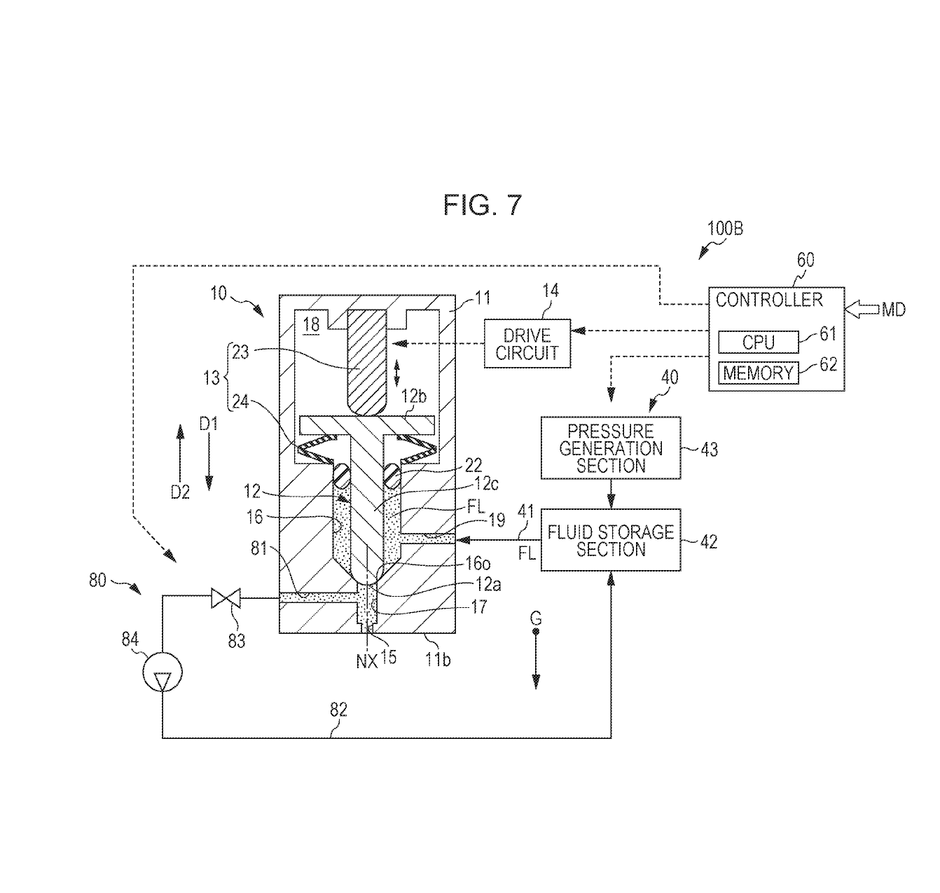

FIG. 7 is a schematic diagram illustrating configuration of a fluid discharge apparatus 100B of a third embodiment. The fluid discharge apparatus 100B of the third embodiment has substantially the same configuration as the fluid discharge apparatus 100 of the first embodiment (FIG. 1), with the exception of the point that a pressure changing mechanism 80 is provided with a different configuration to the pressure changing mechanism 20 of the first embodiment. For the sake of convenience, the formation stage 50, the moving mechanism 52, and the energy application section 55 are omitted from illustration in FIG. 7.

The pressure changing mechanism 80 is provided so as to face the pressure chamber 17. The pressure changing mechanism 80 is connected so as to be capable of acting on fluid FL in the pressure chamber 17, and is actuated to change the pressure of the fluid FL in the pressure chamber 17. The pressure changing mechanism 80 includes a communication path 81, a flow-out tube 82, a control valve 83, and a pump 84. The communication path 81 is provided as a through hole extending from the exterior of the housing section 11 to the pressure chamber 17. The communication path 81 is connected to the fluid storage section 42 of the supply section 40 via the flow-out tube 82.

The control valve 83 is provided in the flow-out tube 82. The control valve 83 is an open/close valve, and opens and closes under the control of the controller 60. The pump 84 is a suction pump driven under the control of the controller 60, and generates drive force to cause fluid FL inside the flow-out tube 82 to flow in a direction toward the fluid storage section 42. The pump 84 may be omitted.

In the fluid discharge apparatus 100B of the third embodiment, during discharge processing to discharge the fluid FL through the discharge port 15 the controller 60 controls movement of the moving body 12 by going through the steps 1 to 3 described in the first embodiment. The controller 60 also controls actuation of the pressure changing mechanism 80 in coordination with the control of the movement of the moving body 12 in the discharge processing.

The controller 60 normally keeps the control valve 83 closed, thus blocking the flow of fluid FL out from the pressure chamber 17 and into the flow-out tube 82. At step 1 of the discharge processing, the controller 60 moves the moving body 12 in the second direction D2, and when the standby duration at step 2 has elapsed, starts moving the moving body 12 in the first direction D1 at step 3. The controller 60 actuates the pressure changing mechanism 80 in a direction to reduce the pressure of the pressure chamber 17 at the same time as, or later than, starting movement of the moving body 12 in the first direction Dl. The controller 60 opens the control valve 83 for a specific momentary duration so as to momentarily relieve pressure of the pressure chamber 17 into the flow-out tube 82.

Accordingly, a force in the direction from the discharge port 15 toward the pressure chamber 17 can be generated in the fluid FL being discharged through the discharge port 15. As described in the first embodiment, this thereby enables separation of a fluid droplet from the fluid FL that is being discharged through the discharge port 15 to be promoted, and also suppresses excess fluid FL from remaining in the peripheral edge region of the discharge port 15. Note that drive force from the pump 84 can be used to guide fluid FL that has flowed out into the flow-out tube into the fluid storage section 42 for reuse in the formation processing. Wastage of the fluid FL is thereby suppressed.

As described above, in the fluid discharge apparatus 100B and the fluid FL discharge method of the discharge processing of the third embodiment, the pressure changing mechanism 80 is actuated in the direction to reduce the pressure of the pressure chamber 17, thereby drawing excess fluid FL back toward the discharge port 15 following fluid FL discharge. Accordingly, excess fluid FL is suppressed from remaining in the peripheral edge region of the discharge port 15. Moreover, the separation of fluid droplets from the fluid FL discharged through the discharge port 15 is promoted, thereby suppressing irregularity in the size of fluid droplets or detriment to the shape of the fluid droplets. Additionally, fluid FL that has flowed out from the pressure chamber 17 as a result of the pressure changing mechanism 80 is circulated and reused, suppressing an increase in running costs of the fluid discharge apparatus 100B. Additionally, the fluid discharge apparatus 100B and the fluid FL discharge method of the discharge processing of the present embodiment are capable of exhibiting various operation and advantageous effects similar to those explained above with regard to the first embodiment.

### D. Modified Examples

### D1. Modified Example 1

The fluid discharge apparatus 100, 100A of the first embodiment and the second embodiment described above is provided with the pressure changing mechanism 20 that changes the capacity of the communication chamber 30 in order to change the pressure inside the pressure chamber 17. The fluid discharge apparatus 100B of the third embodiment described above is provided with the pressure changing mechanism 80 that causes fluid FL to flow from the pressure chamber 17 into the flow-out tube 82 in order to change the pressure inside the pressure chamber 17. By contrast, a fluid discharge apparatus may be provided with a pressure changing mechanism that changes the pressure inside the pressure chamber 17 using a different method to those in the respective embodiments described above. Such a fluid discharge apparatus may, for example, be provided with a pressure changing mechanism that changes the pressure inside the pressure chamber 17 using an actuator such as a piezoelectric element to flex and deform a wall face of the pressure chamber 17 in order to change the capacity of the space inside the pressure chamber 17.

### D2. Modified Example 2

In each of the embodiments described above, the pressure changing mechanism 20, 80 is actuated in the direction to reduce the pressure of the pressure chamber 17 during fluid FL discharge through the discharge port 15. By contrast, the pressure changing mechanism 20, 80 may be actuated in the direction to reduce the pressure of the pressure chamber 17 after a fluid droplet has separated from the fluid FL being discharged through the discharge port 15. Actuating the pressure changing mechanism 20, 80 in a direction to reduce the pressure of the pressure chamber 17 at this timing enables excess fluid FL remaining at the exterior of the discharge port 15 to be sucked into the discharge port 15. Excess fluid FL is thereby suppressed from remaining in the peripheral edge region of the discharge port 15 following fluid FL discharge.

### D3. Modified Example 3

In the first embodiment and the second embodiment described above, the valve body 33 of the pressure changing mechanism 20 performs back and forth operation at a timing instructed by the controller 60 during discharge processing. Moreover, in the third embodiment described above, the control valve 83 of the pressure changing mechanism 80 opens and closes at timings instructed by the controller 60 during discharge processing. By contrast, the valve body 33 of the pressure changing mechanism 20 and the control valve 83 of the pressure changing mechanism 80 need not be actuated under the control of the controller 60 during discharge processing. In the first embodiment and the second embodiment, configuration may be made such that the valve body 33 of the pressure changing mechanism 20 starts to move from the second position P_{S} toward the first position P_{L} mechanically when the pressure of the pressure chamber 17 has reached a predetermined magnitude or greater. For example, the moving body 12 may be biased by a biasing member such that the moving body 12 starts moving from the second position P_{S} toward the first position P_{L} when applied with a predetermined load. Similarly, the control valve 83 of the pressure changing mechanism 80 of the third embodiment may be configured by a valve that opens and closes mechanically when the pressure of the pressure chamber 17 reaches a predetermined magnitude or greater.

### D4. Modified Example 4

In the fluid discharge apparatus 100, 100A of the first embodiment and the second embodiment described above, the valve body 33 is moved back and forth by the piezoelectric element 35a such that the valve body 33 extends and retracts in the communication chamber 30. By contrast, in the fluid discharge apparatus 100, 100A of the first embodiment and the second embodiment, the valve body may be moved back and forth by an alternative method other than the piezoelectric element 35a. For example, the valve body 33 may be moved by a solenoid mechanism, or air pressure may be utilized to move the valve body 33.

### D5. Modified Example 5

In the fluid discharge apparatus 100B of the third embodiment described above, the control valve 83 of the pressure changing mechanism 80 is configured by an open/close valve. By contrast, the control valve 83 may be configured by a flow control valve in which an opening amount is used to regulate the flow rate of the fluid FL in the flow-out tube 82. In such cases, there may be a large, temporary increase in the opening amount of the control valve 83 at the opening timing of the control valve 83 described above in the third embodiment.

### D6. Modified Example 6

In the fluid discharge apparatus 100B of the third embodiment described above, the flow-out tube 82 is connected to the fluid storage section 42, and the fluid FL that flows into the flow-out tube 82 is circulated and reused. By contrast, configuration may be made in which the flow-out tube 82 is not connected to the fluid storage section 42, with the fluid FL that flows into the flow-out tube 82 being stored in another storage section.

### D7. Modified Example 7

In each of the embodiments described above, the discharge processing (FIG. 3) is executed during formation processing to form a three-dimensional object. By contrast, the discharge processing may be executed outside of formation processing. For example, the discharge processing may be executed during flushing performed as maintenance of the discharge section 10.

### D8. Modified Example 8

In each of the embodiments described above, the moving body 12 is displaced by being applied with a load resulting from extension and contraction of the piezoelectric element 23. By contrast, the moving body 12 may be displaced by being applied with load by another method that does not employ the piezoelectric element 23. For example, the moving body 12 may be displaced by being applied with load caused by gas pressure. Moreover, in each of the embodiments described above, the moving body 12 may be integrated together with the piezoelectric element 23, with a leading end portion of the piezoelectric element 23 configured to move back and forth inside the housing section 11 as the moving body 12.

### D9. Modified Example 9

The fluid detection section 70 of the second embodiment described above may be applied to the fluid discharge apparatus 100B of the third embodiment. In such a configuration, the controller 60 may change an opening duration of the control valve 83 according to the amount of fluid FL detected by the fluid detection section 70. The controller 60 may increase the opening duration of the control valve 83 the greater the amount of fluid FL detected by the fluid detection section 70. Moreover, the controller 60 may increase the opening duration of the control valve 83 when the amount of fluid FL detected by the fluid detection section 70 exceeds a specific threshold value.

### D10. Modified Example 10

In each of the embodiments described above, the storage chamber 16 and the pressure chamber 17 are arranged along the central axis NX of the discharge port 15. By contrast, the storage chamber 16 and the pressure chamber 17 may be arranged along a direction intersecting the central axis NX of the discharge port 15. In such cases, the direction of back and forth movement of the moving body 12 may be a direction intersecting the opening direction of the discharge port 15. Moreover, the storage chamber 16 and the pressure chamber 17 may be arranged such that the central axis of the storage chamber 16 and the central axis of the pressure chamber 17 intersect each other. In such a configuration, providing the pressure changing mechanism 20 in a region interposed between the central axis of the storage chamber 16 and the central axis of the pressure chamber 17 enables a more compact configuration of the discharge section 10.

### D11. Modified Example 11

The fluid discharge apparatus 100, 100A, 100B of each of the embodiments described above is implemented as a three-dimensional formation apparatus for forming a three-dimensional object. However, a fluid discharge apparatus need not be implemented as a three-dimensional formation apparatus. The fluid discharge apparatus may, for example, be implemented as an ink jet printer that discharges ink as the fluid, or may be implemented as a painting apparatus that discharges paint, or a processing apparatus that discharges an adhesive having fluid properties.

### D12. Modified Example 12

In the embodiments described above, some or all of the functionality and processing implemented by software may be implemented by hardware. Moreover, some or all of the functionality and processing implemented by hardware may be implemented by software. Examples of hardware that may be employed include various circuits, such as integrated circuits, discrete circuits, and circuit modules combining integrated circuits and discrete circuits.

The invention is not limited to the embodiments, examples, and modified examples described above, and may be implemented by various configurations within a range not departing from the spirit of the invention. For example, the technical features contained in the embodiments, examples, and modified examples that correspond to the technical features of the various aspects described in the “Summary” section may be swapped or combined as appropriate in order to address some or all of the issues mentioned, or in order to achieve some or all of the advantageous effects mentioned. Moreover, unless described as being an essential technical feature in the present specification, such features may be omitted as appropriate.

The entire disclosure of Japanese Patent Application No. 2016-190762, filed Sep. 29, 2016 is expressly incorporated by reference herein.

What is claimed is:

1. A fluid discharge apparatus comprising:
a storage chamber that stores a fluid;
a pressure chamber that includes a discharge port to discharge the fluid, and that is in communication with the storage chamber through a communication opening that opens into the storage chamber;
a moving body that moves inside the storage chamber toward the communication opening, that raises a pressure of the fluid in the pressure chamber, and that discharges the fluid through the discharge port; and
a pressure changing mechanism that is provided so as to face the pressure chamber, that changes a pressure of the pressure chamber, and that actuates in a direction to reduce the pressure chamber pressure after the moving body has started to move toward the communication opening.

2. The fluid discharge apparatus of claim 1, further comprising a controller that controls movement of the moving body, that executes discharge processing to discharge the fluid through the discharge port, and that actuates the pressure changing mechanism in coordination with a timing to move the moving body during the discharge processing.

3. The fluid discharge apparatus of claim 1, wherein the pressure changing mechanism is actuated in a direction to reduce the pressure chamber pressure during discharge of the fluid through the discharge port, and causes at least a portion of the fluid that is being discharged through the discharge port to separate.

4. The fluid discharge apparatus of claim 1, wherein:
the fluid discharge apparatus further comprises a communication chamber that is in communication with the pressure chamber;
the pressure changing mechanism is actuated so as to change a capacity of a space inside the communication chamber; and
actuation of the pressure changing mechanism in a direction to reduce the pressure chamber pressure is actuation to increase the capacity of the space inside the communication chamber.

5. The fluid discharge apparatus of claim 2, wherein:
the fluid discharge apparatus further comprises a communication chamber that is in communication with the pressure chamber;
the pressure changing mechanism is actuated so as to change a capacity of a space inside the communication chamber; and
actuation of the pressure changing mechanism in a direction to reduce the pressure chamber pressure is actuation to increase the capacity of the space inside the communication chamber.

6. The fluid discharge apparatus of claim 5, wherein:
the pressure changing mechanism includes a valve body that performs an extension-retraction operation in the communication chamber so as to change the capacity of the space inside the communication chamber; and
the controller controls the extension-retraction operation of the valve body in coordination with a timing to move the moving body during the discharge processing.

7. The fluid discharge apparatus of claim 6, wherein:
the moving body moves inside the storage chamber in a first direction toward the communication opening and a second direction away from the communication opening; and
during the discharge processing, the controller
discharges the fluid through the discharge port by moving the moving body in the second direction and then moving the moving body in the first direction,
reduces the capacity of the space inside the communication chamber in a period of time after the moving body starting to move in the second direction and prior to the moving body starting to move in the first direction, and
increases the capacity of the space inside the communication chamber in a period of time after the moving body has started to move in the first direction.

8. The fluid discharge apparatus of claim 2, wherein:
the fluid discharge apparatus further comprises a fluid detection section that detects any of the fluid present at a peripheral edge region of the discharge port at the exterior of the pressure chamber; and
during discharge processing, the controller controls the degree of pressure reduction by the pressure changing mechanism according to an amount of the fluid detected by the fluid detection section.

9. A method for discharging a fluid from a discharge port, the method comprising:
inside a storage chamber that stores the fluid, moving a moving body toward a communication opening that opens into the storage chamber and is in communication with a pressure chamber including the discharge port, raising a pressure of the fluid in the pressure chamber, and starting discharge of the fluid through the discharge port; and
actuating a pressure changing mechanism provided so as to face the pressure chamber and to change a pressure of the pressure chamber, the actuation being in a direction to reduce the pressure chamber pressure after the moving body has started to move toward the pressure chamber.
